(19) United States
(12) Patent Application Publication
(10) Pub. No.: US 2018/0099418 A1
(43) Pub. Date: Apr. 12, 2018

(54) JOINT UNIT

(71) Applicant: WEISS GmbH, Buchen (Odw.) (DE)

(72) Inventors: René Hedrich, Augsburg (DE); Tobias Frank, Adelshem (DE)

(21) Appl. No.: 15/725,567

(22) Filed: Oct. 5, 2017

(30) Foreign Application Priority Data
Oct. 6, 2016 (DE) 102016119009.8

(51) Int. Cl. B25J 17/02

(52) U.S. Cl. CPC B25J 17/025

(57) ABSTRACT

The present invention relates to a joint unit for an articulated connection of at least one first component and one second component. The joint unit comprises a joint body, in particular a sleeve-like joint body, connectable to the first component. A first joint element is arranged rotatably supported about a first axis of rotation in the joint body. The first joint element has at least one bearing section that receives a second joint element that is rotatably supported about a second axis of rotation and that is connectable to the second component.

The present invention relates to a joint unit for an articulated connection of at least one first component and one second component.

Such joint units are used in a plurality of machines to be able to pivot and/or rotate components relative to one another that are connected to one another. For example, there is a great need for inexpensive and compact joint units in robotics that serve a reliable connection of individual parts of a robot arm.

In accordance with the invention, such a joint unit has the features of claim 1.

The joint unit in accordance with the invention has a joint body that is connectable to a first component and that is in particular formed like a sleeve. A first joint element is arranged supported rotatably about an axis of rotation in the joint body. The named joint element has at least one bearing section that receives a second joint element that is rotatably supported about a second axis of rotation and that is connectable to a second component.

In other words, the joint unit in accordance with the invention enables a connection of two components that is pivotable about two axes of rotation. A flexibly usable joint unit is thus provided using comparatively few components. The joint unit has a very compact construction and can moreover be manufactured inexpensively due to the small number of required components.

Further embodiments of the invention are set forth in the description, in the Figures and in the claims.

In accordance with an advantageous embodiment, the first and second axes of rotation are arranged substantially perpendicular to one another. The two axes of rotation can, however, also extend obliquely to one another for particular applications. The straight lines defined by the axes of rotation in particular intersect. It is, however, also by all means conceivable that a lateral offset is provided as required between the straight lines defined by the two axes of rotation so that these straight lines do not intersect.

To simplify the fastening of the second component, the bearing section can project laterally out of the joint body.

A particularly simple and robust construction is achieved when the first joint element is supported directly in the joint body. A plain bearing support is admittedly possible in principle, but a support by means of rolling elements, in particular balls, is preferred. This also applies to embodiments in which no direct support of the joint element in the joint bodies is present, but in which further components are arranged between the joint element and the joint body.

The first joint element can be formed in one piece to increase the manufacturing costs and the robustness of the joint unit in accordance with the invention. This also applies to the second joint element.

In accordance with a further embodiment, the second joint elements is supported in a body, in particular in a sleeve-like body. The body can be arranged in a receiver of the bearing section. This receiver is, for example, a bore that is easy to manufacture. it is, however, generally also conceivable to support the second joint elements directly in the receiver, in particular by means of rolling elements.

In accordance with a further embodiment, the joint element has two bearing sections that are arranged at opposite ends of the first joint element. The first joint element is preferably designed symmetrically with a plane of symmetry that extends perpendicular to the first axis of rotation. The sleeve-like joint body can in principle also have such a symmetry.

The second joint element can have a section that is provided for fastening the second component. The section can project from the body and/or be at least sectionally provided with a thread, in particular with an external thread. Such a construction facilitates the fastening of the second component.

The invention further relates to a manipulation device, in particular to a robot, that has an articulated manipulation arm, i.e. a manipulation arm that has different sections that are connected to one another in an articulated manner and that are pivotable relative to one another. In accordance with the invention, the named manipulation device comprises at least one joint unit in accordance with any one of the above-described embodiments.

In accordance with an embodiment, the manipulation device has these three articulated manipulation arms. The named manipulation device is a tripod robot, for example. Each manipulation arm has a first arm section that is connected to a drive motor. A second arm section is furthermore provided that is connected to a base common to the three manipulation arms. The first and second arm sections are each connected to one another by a joint unit in accordance with at least one of the above-described embodiments. The second arm section is furthermore respectively connected to the base by a joint unit in accordance with the invention.

The second arm section can comprise two arm elements arranged substantially in parallel.

The present invention will be described in the following with reference to advantageous embodiments and to the enclosed drawings. There are shown:

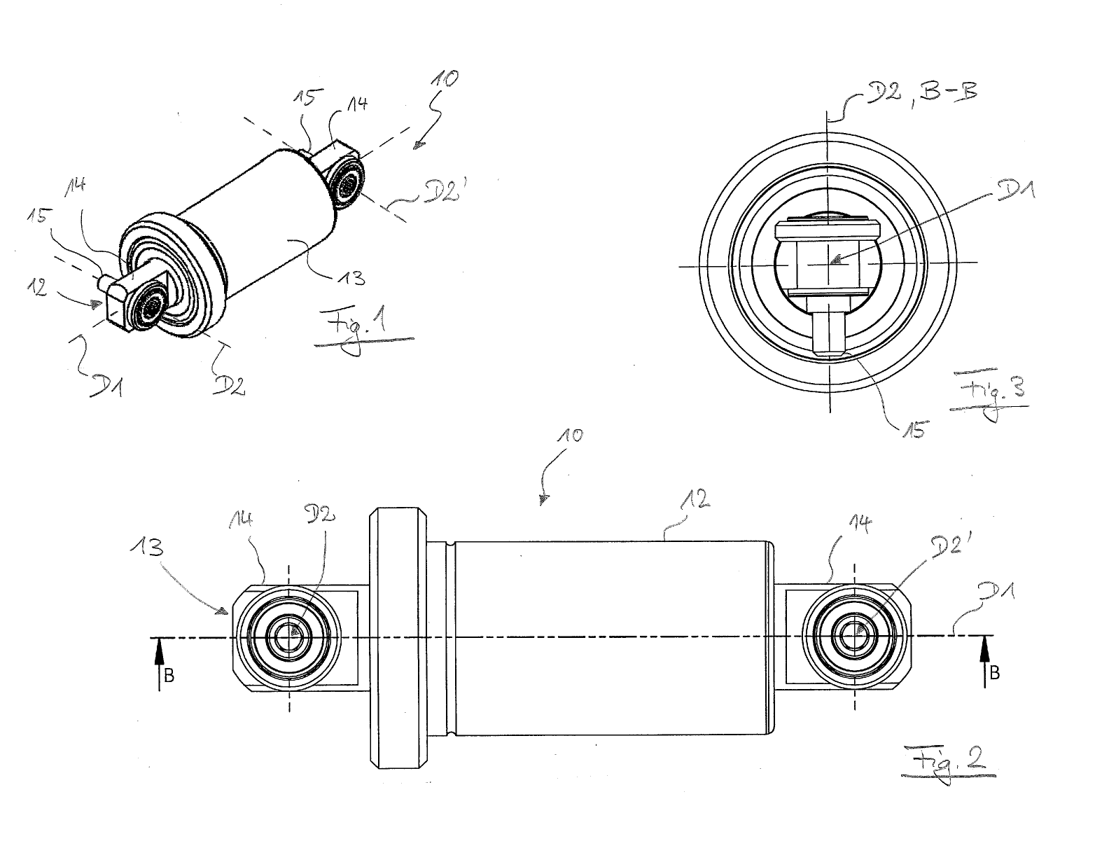

FIG. 1 a perspective view of an embodiment of the joint unit in accordance with the invention;

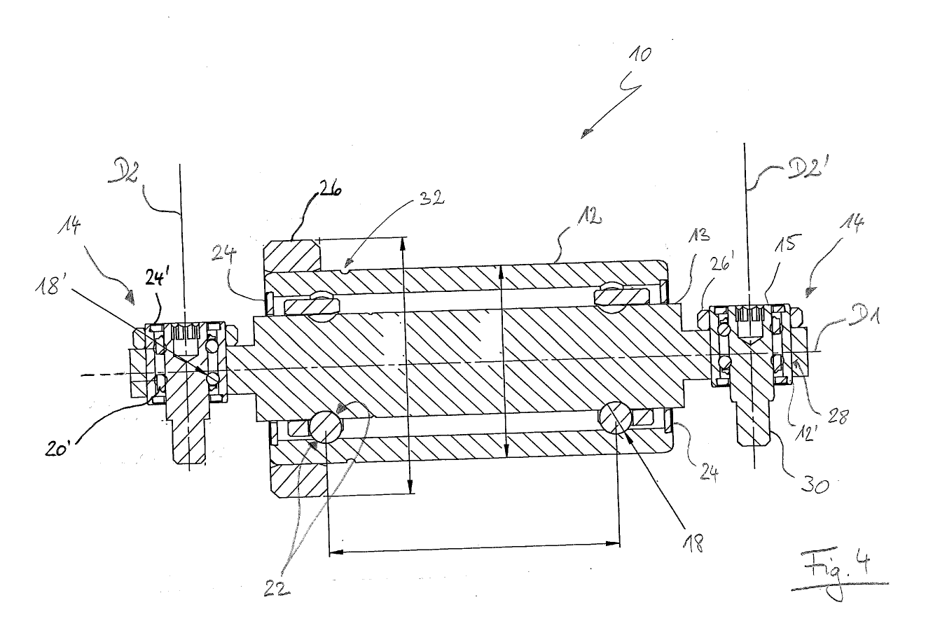

FIGS. 2 and 3 a side view and front view respectively of the joint unit shown in FIG. 1;

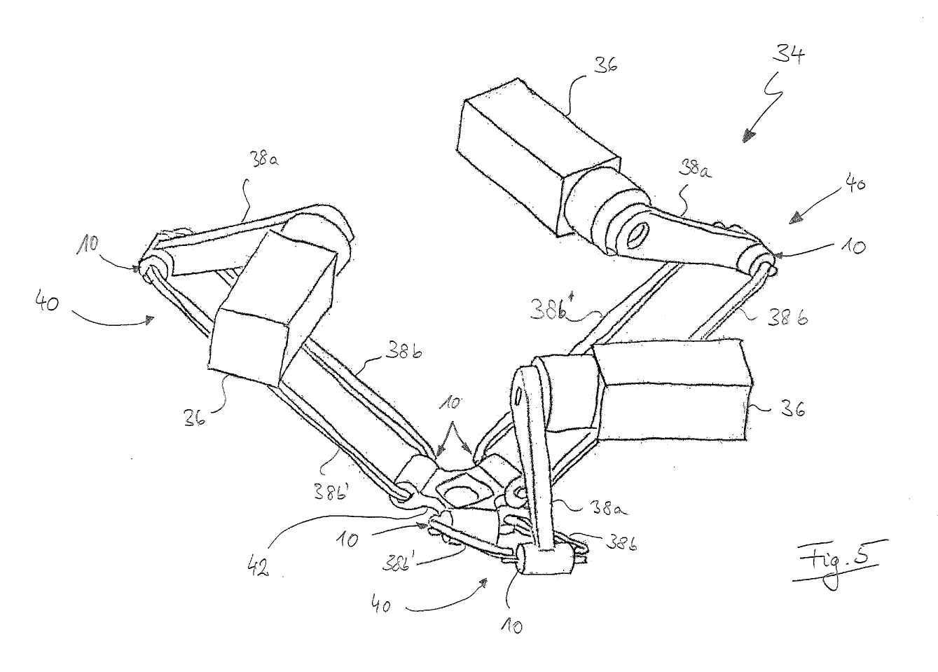

FIG. 4 a section through the joint unit shown in FIGS. 1 to 3 through the sectional plane B-B indicated in FIGS. 2 and 3; and

FIG. 5 an embodiment of a manipulation device in accordance with the invention.

FIG. 1 shows a joint unit 10 in a perspective view. The joint unit 10 comprises a joint element 13 that is rotatable about an axis of rotation D1 and that is arranged in a sleeve-like joint body 12. The joint element 13 has respective bearing sections 14 at its two ends and a respective joint element 15 rotatably supported about axes of rotation D2 and D2′ respectively is supported at them. The axes of rotation D2, D2′ arranged in parallel with one another intersect the axis of rotation D1 at a right angle.

FIG. 2 shows the joint unit 10 in a side view so that the axes of rotation D2, D2′ are perpendicular the plane of the drawing.

FIG. 3 shows the joint unit 10 in a front view, that is in the direction of the axis of rotation D1. The axis of rotation D1 thus extends perpendicular to the plane of the drawing.

The design of the joint unit 10 will be explained in more detail in the following with reference to FIG. 4. It shows a sectional view in the sectional plane B-B whose position is drawn in FIGS. 2 and 3.

As can be recognized in FIG. 4, the joint element 13 is supported directly in the joint body 12 by a plurality of balls 18. The balls 18 are secured in their position by ball cages 20 so that two ball races are formed that reliably support the joint element 13. The balls 18 are then located in grooves 22 provided at the joint body 12 and at the joint element 13 in the installed position.

The joint element 13 is ultimately a kind of shaft that is directly supported in a kind of bearing sleeve (here the joint body 12). The following procedure is followed on the assembly of the unit 10: First, the balls 18 are introduced into the grooves 22 of the joint body 12. They contact one another in this process and fill up a portion of the periphery of the grooves 22. The joint element 13 is subsequently introduced and the balls 18 are distributed in the peripheral direction and are secured in their positions by the corresponding ball cage 20. The end faces of the joint body 12 are subsequently closed by circlips 24 to protect the interior of the joint body 12 from contamination. A fixing ring 26 is furthermore applied to the joint body 12 from the outside. It is dimensioned such that it exerts a force acting on the joint body 12 in the radial direction to preload and thus secure the latter.

Bores 28 are provided in the bearing sections 14. The bores 28 each receive a bearing arrangement that is designed in a similar manner to the above-described support of the joint element 13. A respective one joint body 12′ is provided in this respect in which a respective joint element 15 is supported by means of balls 18′. The balls 18′ are held in their positions by ball cages 20′. The assembly takes place as described above. Circlips 24′ and a respective fixing ring 26′ are likewise provided. The securing of the respective joint body 12′ in the corresponding bore 28 can take place, for example, by adhesive bonding and/or by a force transmission. Other fixing possibilities are also conceivable, such as screwing or (spot) welding.

The joint element 15 has a threaded section 30 at the side remote from the ring 26′ and a component is fastenable thereto.

The joint body 12 is in turn connectable to a further component, for example to a section of a robot arm. This section, for example, has a bore into which the joint body 12 can be pushed and is fixable there, for example by means of adhesive bonding, welding, screwing and/or by means of a press fit. The ring 26 can in this respect serve as an abutment to define an insertion depth of the joint body 12.

In the example specifically shown, the use of an adhesive is provided to fix the joint body 12. On an insertion of the joint body 12 into a corresponding receiver (an insertion movement would be a movement of the unit 10 to the right in FIG. 4), adhesive is stripped off to the left under certain circumstances. This excess adhesive is at least partly received by a reception groove 32 in this process.

FIG. 5 shows a tripod robot 34 in which six of the above-described joint units 10 are used. The tripod robot 34 has three motors 36 that are fastened to a common rack, not shown. The motors 36 generate rotational movements that are converted into a pivoting of an arm section 38a of a respective manipulator arm 40 respectively associated with them. At the ends of the arm sections 38a remote from the motors 36, a reception bore is provided into which a respective joint unit 10 is inserted and is fixed there. Respective arm sections 38b, 38b′ are fastened to the joint elements 15 of the joint units 10. The other ends of the arm sections 38b, 38b′ are connected in an analog form to a base 42 via a respective further joint unit 10. A tool, a gripper or similar can be fastened to the base 42, for example.

A precise movement of the base 42 in space can be generated by a selective control of the motors 36. The compact and reliable joint units 10 in this process ensure the required pivotability of the components 38a, 38b, 38b′ or 38b, 38′, 42 relative to one another.

### REFERENCE NUMERAL LIST

10 joint unit
12, 12′ joint body
13, 15 joint element
14 bearing section
18, 18′ ball
20, 20′ ball cage
22 groove
24, 24′ circlip
26, 26′ fixing ring
28 bore
30 threaded section
32 reception groove
34 tripod robot
36 motor
38a, 38b, 38b′ arm section
40 manipulator arm
42 base
D1, D2, D2′ axis of rotation
B-B sectional plane

1. A joint unit for an articulated connection of at least one first component and one second component, the joint unit comprising a joint body which is connectable to the first component, and in which joint body a first joint element is arranged which is rotatably supported about a first axis of rotation, wherein the first joint element has at least one bearing section that receives a second joint element that is rotatably supported about a second axis of rotation and that is connectable to the second component.

2. The joint unit in accordance with claim 1,
wherein the joint body which is a sleeve-like joint body.

3. The joint unit in accordance with claim 1,
wherein the first and second axes of rotation are arranged substantially perpendicular to one another.

4. The joint unit in accordance with claim 1,
wherein the bearing section projects laterally out of the joint body.

5. The joint unit in accordance with claim 1,
wherein the first joint element is directly supported in the joint body.

6. The joint unit in accordance with claim 1,
wherein the first joint element is directly supported in the joint body by means of rolling elements.

7. The joint unit in accordance with claim 1,
wherein at least one of the first joint element and the second joint element is formed in one piece.

8. The joint unit in accordance with claim 1,
wherein the second joint element is supported in a body that is arranged in a receiver of the bearing section.

9. The joint unit in accordance with claim 8,
wherein the body is a sleeve-like body.

10. The joint unit in accordance with claim 8,
wherein the receiver is a bore of the bearing section.

11. The joint unit in accordance with claim 8,
wherein the second joint element is directly supported in the body.

12. The joint unit in accordance with claim 8,
wherein the second joint element is directly supported in the body by means of rolling elements.

13. The joint unit in accordance with claim 1,
wherein the first joint element has two bearing sections that are arranged at opposite ends of the first joint element.

14. The joint unit in accordance with claim 1,
wherein the first joint element is designed symmetrically with a symmetry plane that extends perpendicular to the first axis of rotation.

15. The joint unit in accordance with claim 1,
wherein the second joint element has a section that is provided for fastening the second component, with the section projecting from the body and/or being at least sectionally provided with a thread.

16. The joint unit in accordance with claim 1,
wherein the section is at least sectionally provided with an external thread.

17. A manipulation device having at least one articulated manipulation arm that comprises a joint unit for an articulated connection of at least one first component and one second component, said joint unit comprising a joint body which is connectable to the first component, and in which joint body a first joint element is arranged which is rotatably supported about a first axis of rotation, wherein the first joint element has at least one bearing section that receives a second joint element that is rotatably supported about a second axis of rotation and that is connectable to the second component.

18. The manipulation device in accordance with claim 17,
wherein it is a robot.

19. The manipulation device in accordance with claim 17,
wherein the manipulation device has three articulated manipulation arms, with each manipulation arm comprising a first arm section that is connected to a drive motor and a second arm section that is connected to a base common to the three manipulation arms, with the first and section arm sections each being connected to one another in an articulated manner by a joint unit for an articulated connection of at least one first component and one second component, said joint unit comprising a joint body which is connectable to the first component, and in which joint body a first joint element is arranged which is rotatably supported about a first axis of rotation, wherein the first joint element has at least one bearing section that receives a second joint element that is rotatably supported about a second axis of rotation and that is connectable to the second component, and with the second arm section being respectively connected to the base in an articulated manner by a joint unit for an articulated connection of at least one first component and one second component, said joint unit comprising a joint body which is connectable to the first component, and in which joint body a first joint element is arranged which is rotatably supported about a first axis of rotation, wherein the first joint element has at least one bearing section that receives a second joint element that is rotatably supported about a second axis of rotation and that is connectable to the second component.

20. The manipulation device in accordance with claim 19,
wherein it is a tripod robot.

21. The manipulation device in accordance with claim 19, wherein the second arm section comprises two arm elements arranged substantially in parallel.
